(19) United States
(12) Patent Application Publication
(10) Pub. No.: US 2023/0342667 A1
(43) Pub. Date: Oct. 26, 2023

(54) CLASSIFICATION MODEL TRAINING METHOD, SEMANTIC CLASSIFICATION METHOD, DEVICE AND MEDIUM

(71) Applicant: BEIJING BAIDU NETCOM SCIENCE TECHNOLOGY CO., LTD., Beijing (CN)

(72) Inventors: Zenan LIN, Beijing (CN); Huapeng QIN, Beijing (CN); Min ZHAO, Beijing (CN); Guoxin ZHANG, Beijing (CN); Yajuan LV, Beijing (CN)

(73) Assignee: BEIJING BAIDU NETCOM SCIENCE TECHNOLOGY CO., LTD., Beijing (CN)

(21) Appl. No.: 18/179,266

(22) Filed: Mar. 6, 2023

(30) Foreign Application Priority Data
Apr. 22, 2022 (CN) 202210439044.9

(51) Int. Cl. G06N 20/00

(52) U.S. Cl. CPC G06N 20/00

(57) ABSTRACT

A semantic classification model training method includes that a sample query template and a label category of at least one category to be predicted in the sample query template are acquired, where the sample query template is constructed according to a sample query statement and a number of the at least one category to be predicted; the sample query template is input to the pre-constructed semantic classification model to obtain a sample semantic category of the at least one category to be predicted; and the semantic classification model is trained according to the sample semantic category and the label category of the at least one category to be predicted.

### CROSS-REFERENCE TO RELATED APPLICATION

This application claims priority to Chinese Patent Application No. 202210439044.9 filed Apr. 22, 2022, the disclosure of which is incorporated herein by reference in its entirety.

### TECHNICAL FIELD

The present disclosure relates to the technical field of artificial intelligence and, in particular, to the technologies of knowledge graph, deep learning, and natural semantic processing.

### BACKGROUND

Text classification, also referred to as automatic text classification, refers to a process in which a computer maps a text carrying information to a given category or given categories of subjects, which can be used in a variety of scenes such as emotion analysis, topic marking, news classification, question-answering system, natural language reasoning, dialog behavior classification, relationship classification, and event prediction.

### SUMMARY

The present disclosure provides a classification model training method and apparatus, a semantic classification method and apparatus, a device and a medium.

According to one aspect of the present disclosure, a classification model training method is provided. The method includes steps described below.

A sample query template and a label category of at least one category to be predicted in the sample query template are acquired, where the sample query template is constructed according to a sample query statement and a number of the at least one category to be predicted.

The sample query template is inputted to the pre-constructed semantic classification model to obtain a sample semantic category of the at least one category to be predicted.

The semantic classification model is trained according to the sample semantic category and the label category of the at least one category to be predicted.

According to another aspect of the present disclosure, a semantic classification method is further provided. The method includes steps described below.

A prediction query template is acquired, where the prediction query template is constructed according to a prediction query statement and a number of at least one category to be predicted.

A prediction semantic category of the at least one category to be predicted is obtained according to the prediction query template.

According to another aspect of the present disclosure, an electronic device is provided. The electronic device includes at least one processor, and a memory communicatively connected to the at least one processor.

The memory is configured to store instructions executable by the at least one processor to cause the at least one processor to perform the classification model training method and/or the semantic classification method according to any embodiment of the present disclosure.

According to another aspect of the present disclosure, a non-transitory computer-readable storage medium is provided. The storage medium is configured to store computer instructions for causing a computer to perform the classification model training method and/or the semantic classification method according to any embodiment of the present disclosure.

According to the technologies of the present disclosure, the generality of the model is improved, and a sample imbalance problem can be dealt with.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solutions and not to limit the present disclosure.

FIG. 1A is a flowchart of a classification model training method according to an embodiment of the present disclosure;

FIG. 1B is a diagram illustrating the structure of a semantic classification model according to an embodiment of the present disclosure;

FIG. 2 is a flowchart of another classification model training method according to an embodiment of the present disclosure;

FIG. 3 is a flowchart of another classification model training method according to an embodiment of the present disclosure;

FIG. 4A is a flowchart of a semantic classification method according to an embodiment of the present disclosure;

FIG. 4B is a diagram illustrating the structure of a semantic classification model according to an embodiment of the present disclosure;

FIG. 5 is a flowchart of another semantic classification method according to an embodiment of the present disclosure;

FIG. 6 is a diagram illustrating the structure of a classification model training apparatus according to an embodiment of the present disclosure;

FIG. 7 is a diagram illustrating the structure of a semantic classification apparatus according to an embodiment of the present disclosure; and

FIG. 8 is a block diagram of an electronic device for performing a classification model training method and/or a semantic classification method according to an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

Each classification model training method provided in the embodiment of the present disclosure may be applicable to a scene in which a semantic classification model is trained, and executed by a classification model training apparatus. The apparatus may be implemented by software and/or hardware and is specifically configured in an electronic device.

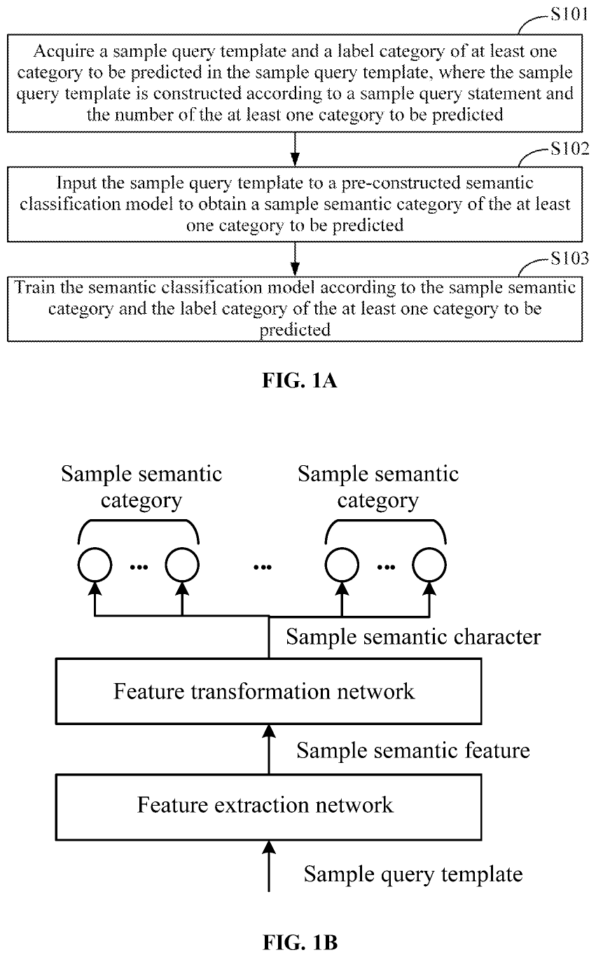

Referring to FIG. 1A, a semantic classification model training method includes the steps described below.

In S101, a sample query template and a label category of at least one category to be predicted in the sample query template are acquired, where the sample query template is constructed according to a sample query statement and the number of the at least one category to be predicted.

A query statement may be understood as a statement constructed by at least one semantic character, and the sample query statement is a query statement as a training sample in a model training process. The category to be predicted may be understood as the category in which the sample query statement is most predictable. The number of categories to be predicted may be set by a technician according to requirements or empirical values or determined by a large number of trials. The number of categories to be predicted is at least one. In order to avoid the omission of semantic category predictions in the semantic classification model obtained by subsequent training, the number of categories to be predicted is generally set to at least two, such as five.

It is be noted that the category to be predicted is at least one of the predictable categories, and generally the number of categories to be predicted will be significantly less than the number of predictable categories.

The sample query template is a statement having a uniform format requirement constructed on the basis of the sample query statement and the number of categories to be predicted. A label category of the category to be predicted may be understood as a standard semantic category corresponding to a preset sample query statement. The present disclosure does not limit the specific setting of the label category, for example, the setting may be implemented by manual labeling.

It is to be noted that the sample query template and/or the corresponding label category may be stored locally in the computing device performing the classification model training, or in other storage devices or clouds associated with the computing device, and the corresponding data acquisition is performed as required. The present disclosure does not limit the above data acquisition manner.

Optionally, the sample query statement may be acquired before performing the classification model training, and the sample query template may be constructed in real time for subsequent classification model training according to the sample query statement and the number of categories to be predicted.

It is be noted that the computing device acquiring the sample query template and the corresponding label category may be the same as or different from the computing device constructing the sample query template, which is not limited in the present disclosure.

In S102, the sample query template is inputted to the pre-constructed semantic classification model to obtain a sample semantic category of the at least one category to be predicted.

The sample query template as a training sample is inputted to the pre-constructed semantic classification model to obtain a sample semantic category of the at least one category to be predicted in the sample query template. It is to be noted that the number of predicted sample semantic categories only need to be no more than the number of categories to be predicted, and the present disclosure does not limit the specific number of the predicted sample semantic categories.

The semantic classification model may be implemented according to the existing machine learning model or the deep learning model, and the present disclosure does not limit the specific network structure of the semantic classification model. Exemplarily, the semantic classification model may be implemented using a Pre-trained Language Model (PLM). For example, the semantic classification model may be a Bidirectional Encoder Representation from Transformers (BERT) or an Enhanced Representation through Knowledge Integration (ERNIE) model, etc.

In an optional embodiment, the sample query template as the training sample may be inputted directly to the pre-constructed semantic classification model, and the output of the semantic classification model may be directly used as the sample semantic category of the category to be predicted.

In another optional embodiment, the sample query template may be inputted to the pre-constructed semantic classification model to obtain at least one sample semantic character of the category to be predicted, and the at least one sample semantic character is combined in a prediction sequence to obtain the sample semantic category of the category to be predicted.

The sample semantic character of the category to be predicted may be understood as character information corresponding to the semantic feature of the extracted sample query template under the dimension of the category to be predicted. Exemplarily, for any dimension of the category to be predicted, since the number of possible sample semantic characters is at least one, at least one sample semantic character can be sequentially combined according to the prediction sequence of the at least one sample semantic character to obtain the sample semantic category of the category to be predicted.

It can be understood that firstly, the sample semantic characters are predicted, and then the semantic sample characters are sequentially combined according to the prediction sequence to obtain the sample semantic category of the category to be predicted, so as to determine the sample semantic category, thereby improving the determination mechanism of the sample semantic category. Meanwhile, since the particle size of the sample semantic character is small, the semantic feature can be extracted by the character particle size, thereby improving the accuracy of the predicted sample semantic characters.

Exemplarily, the sample query template is inputted to the pre-constructed semantic classification model to extract a sample semantic feature in the sample query template, and feature transformation is performed on the sample semantic feature to obtain at least one sample semantic character of the at least one category to be predicted. The number of sample semantic characters of each category to be predicted may be the same or different. The present disclosure only restricts the maximum number of sample semantic characters of different categories to be predicted.

Specifically, in conjunction with the structure diagram of the semantic classification model shown in FIG. 1B, the semantic classification model may include a feature extraction network and a feature transformation network. For any category to be predicted, feature extraction may be performed on the sample query template through the feature extraction network in the dimension of the at least one category to be predicted to obtain the sample semantic feature in the dimension of the at least one category to be predicted, and the feature transformation is performed on the sample semantic feature through the feature transformation network, thereby mapping the sample semantic feature from a semantic feature space to a semantic character space, and matching the mapping result under the semantic character space with the standard semantic character library to obtain the sample semantic character. Correspondingly, at least one sample semantic character is combined in the prediction sequence to obtain the sample semantic category of the at least one category to be predicted.

The feature transformation may take the form of a linear feature transformation or a non-linear feature transformation, which is not limited by the present disclosure. The standard semantic character library may be set or adjusted by a technician according to requirements or empirical values or set by a large number of trials.

It can be understood that the above technical solution only performs the determination of the sample semantic character by means of feature transformation, without complicated data processing, thereby simplifying the data calculation amount in the process of determining the sample semantic character, and contributing to improving the model training efficiency.

S103, the semantic classification model is trained according to the sample semantic category and the label category of the at least one category to be predicted.

According to the difference between the sample semantic category and the label category of the label to be predicted, a loss function is determined, and model parameters of the semantic classification model are adjusted according to the loss function, so as to reduce the difference between the sample semantic label and the label category, and improve the classification capability of the semantic classification model until the trained semantic classification model satisfies the training termination condition.

The training termination condition may be at least one of the following: the number of sample query templates of the training semantic classification model satisfies the preset number threshold, the function value of the loss function tends to be stable, or the model evaluation index satisfies the preset evaluation index threshold. The specific values of the preset number threshold and the preset evaluation index threshold may be set by a technician according to requirements or empirical values or determined by a large number of trials. The model evaluation index may include at least one of accuracy, sensitivity, specificity, or the like.

In the embodiments of the present disclosure, the pre-constructed semantic classification model is trained by acquiring the sample query template constructed according to the sample query template and the number of categories to be predicted, and according to the sample query template and the label category of the category to be predicted. Since the present disclosure trains the semantic classification model according to a uniform sample query template, and performs the sample classification from a semantic dimension rather than an inter-category difference dimension, the trained semantic classification model can adapt to various classification scenes, and different classification models do not need to be trained for different classification scenes, thereby improving the generality of the trained semantic classification model. Meanwhile, the uniform integration of various sample query statements in the form of templates can effectively deal with the problem of sample imbalance in various category prediction scenes, thereby contributing to improving the small sample classification capability of the trained semantic classification model.

The present disclosure further provides an optional embodiment based on the preceding various technical solutions. In this optional embodiment, the construction mechanism of the sample query template used in S101 is refined. It is to be noted that for the part not detailed in the embodiment of the present disclosure, reference may be made to related expressions of other embodiments.

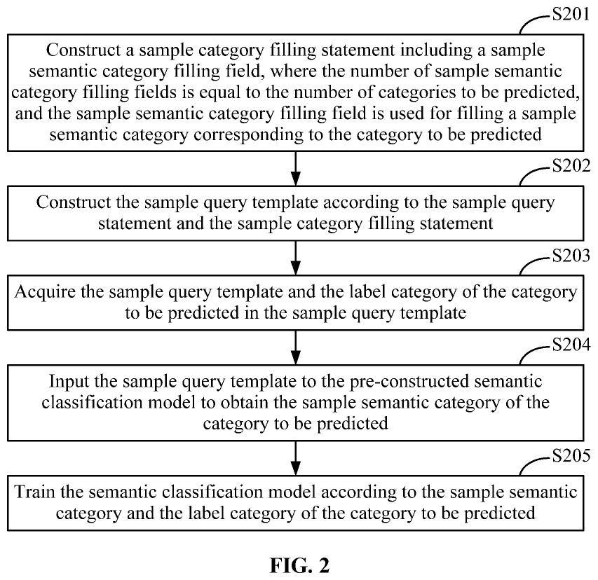

Referring to FIG. 2, a classification model training method includes the steps described below.

In S201, a sample category filling statement including at least one sample semantic category filling field is constructed, where the number of the at least one sample semantic category filling field is equal to the number of the at least one category to be predicted, and the at least one sample semantic category filling field is used for filling a sample semantic category corresponding to the at least one category to be predicted.

The sample semantic category filling field may be a preset blank region or a region to which a preset identification is added. The preset identification may be set or adjusted by a technician according to requirements or empirical values, for example, the preset identification may be a null value or a “MASK” marking.

It can be understood that to facilitate distinguishing different sample semantic categories in the sample category filling statement, field delimiters may be added between different sample semantic category filling fields. The field delimiters may be implemented by using a preset character, and the present disclosure does not limit the specific expression of the preset character. For example, the preset character may be a comma, a pause, a space, other symbol, or the like.

It is to be noted that the categories to be predicted referred to in the present disclosure may be categories under the same system or categories under different systems. The systems to which the different categories to be predicted may be set and adjusted by a technician according to requirements or empirical values, and the kind of the systems is also not limited in the present disclosure.

For example, both the subject and the intention systems may be divided. A category having a species attribution attribute is divided into the subject system, for example, a figure, an entertainment figure, etc., which belong to the subject system. The category having a data acquisition intention is divided into the intention system, for example, height, weight, etc., which belong to the intention system.

When the number of categories to be predicted is at least one, and the systems to which different categories to be predicted belong are different, that is, the number of systems to which various categories to be predicted belong is at least one, for any system, the sample system filling clause including the sample semantic category filling field may be constructed, where the number of sample semantic category filling fields is equal to the number of categories to be predicted under the any system; and the sample category filling statement is determined according to different sample system filling clauses.

Specifically, for any system, an equal number of sample semantic category filling fields are set according to the number of categories to be predicted under the any system, and the sample system filling clause including the set sample semantic category filling fields is constructed. When the number of categories to be predicted corresponds to at least two systems, the sample category filling statement is determined according to various sample system filling clauses corresponding to different systems.

Exemplarily, sample system filling clauses corresponding to different systems may be combined to obtain the sample category filling statement. Further, in order to facilitate dividing the categories to be predicted in different systems, clause delimiters may be set between the different sample system filling clauses in a case of generating the sample category filling statements. The clause delimiters may be implemented by using a preset character, and the present disclosure does not limit the specific expression of the preset character. For example, the preset character may be a comma, a pause, a space, other symbol, or the like. It is to be noted that the clause delimiters may be the same as or different from the preceding field delimiters, and it is only necessary to ensure that different sample system filling clauses can be distinguished.

It can be understood that, by introducing a system to which the category to be predicted belongs, the sample system filling clause is constructed for each system, and then the sample category filling statement is determined according to the sample system filling clause so that the generated sample category filling statement can be systemically divided into the category to be predicted. Meanwhile, since the sample category filling statement is used as the basis for generating the sample query template, it is convenient to add or adjust the system, so that the subsequent training of the semantic classification model for different systems is not required, and the various sample query statements can be adapted, which is helpful to improve the generality of the model. Moreover, in the training process of the multi-system multi-category semantic classification model, the network parameters trained by different sample query statements can be multiplexed, which is helpful to improving the training efficiency.

Further, when the multi-system multi-category sample query template is introduced, in model training process, cross-enhancement of semantic features in different dimensions is usually performed inside the model, thereby helping to improve the semantic feature extraction capability of the trained model, and further helping to improve the accuracy of the trained model.

It is to be noted that in order to facilitate dividing the categories to be predicted in different systems, same field delimiters may be set between the sample system filling clauses in the same systems, and different field delimiters may be set in different sample system filling clauses.

In S202, the sample query template is constructed according to the sample query statement and the sample category filling statement.

The sample query template including the sample query statement and the sample category filling statement is generated.

Exemplarily, the sample query statement and the sample category filling statement are combined to obtain the sample query template. Further, in order to ensure the readability of the obtained sample query template after the sample semantic category is filled in the sample semantic category filling field of the sample query template when the sample semantic category is predicted subsequently, a connection statement may be added between the sample query statement and the sample category filling statement when the sample query template is constructed. The connection statement may be set artificially, for example, the connection statement may be a conjunction. Of course, in order to enhance the readability of the sample query template of which the sample semantic category filling field is filled by the sample semantic category, the connection statement may be added between different sample system filling clauses. The present disclosure does not limit the number and content of connection statements at different positions in the sample query template.

For example, if the sample query statement is “Zhang San's height and weight”, the system to which the category to be predicted belongs includes the subject system and the intention system, and the number of categories to be predicted corresponding to each system is three, the following template can be constructed: “Zhang San's height and weight are “[MASK], [MASK], [MASK]; [MASK], [MASK], [MASK]”. “[MASK]” is the sample semantic category filling field, “[MASK], [MASK], [MASK]; [MASK], [MASK], [MASK]” is the sample category filling statement; “is” is a conjunction, and “[MASK], [MASK], [MASK]” is the sample system filling clause corresponding to the subject system, where “,” is the field delimiter corresponding to the subject system; and “[MASK], [MASK], [MASK]” is the sample system filling clause corresponding to the intention system, where “,” is the field delimiter corresponding to the intention system, and “;” is the clause delimiter between the sample system filling clauses in different systems. Of course, the constructed sample query template is only described above exemplarily, and is not to be construed as limiting the construction manner of the sample query template.

In S203, the sample query template and the label category of the at least one category to be predicted in the sample query template are acquired.

In S204, the sample query template is inputted to the semantic classification model to be pre-constructed to obtain the sample semantic category of the at least one category to be predicted.

Continuing the previous example, if the sample query template is “Zhang San's height and weight are [MASK], [MASK], [MASK]; [MASK], [MASK], [MASK]”, the categories to be predicted under the determined subject system include “figure” and “entertainment figure”, and the categories to be predicted under the determined intention system include “height” and “weight”, the sample semantic category filling field in the sample query template is filled to obtain” Zhang San's height and weight are figure, entertainment figure, [MASK]; height, weight, [MASK]”. In order to ensure the simplicity of the filled sample query template, the unfilled sample semantic categories and adjacent field delimiters may not be displayed. That is, the filled sample query template may be “Zhang San's height and weight are character, entertainment character; height, weight”.

In S205, the semantic classification model is trained according to the sample semantic category and the label category of the at least one category to be predicted.

In the embodiments of the present disclosure, the sample category filling statement is constructed by introducing the sample semantic category filling field, and the sample query template is constructed according to the sample query statement and the sample category filling statement, thereby improving the construction mechanism of the sample query template and providing data support for training the semantic classification model. Meanwhile, the sample query template is generated for different sample query statements in the uniform manner, so that the network structure can train better classification capability without a particularly complex semantic classification model, thereby simplifying the model complexity and helping to improve training efficiency.

It is to be noted that in the training process of the semantic classification model, the semantic classification model gradually has the capability to divide the semantic classifications according to the semantic feature in the sample query template. Since the label category of the category to be predicted in the sample query template may be labelled unreasonably in the labeling process, the label category error-correcting mechanism may be introduced to correct the labeling unreasonable label category, so that the classification capability of the semantic classification model is affected due to the labeling error of the label category.

In view of this, the present disclosure further provides an optional embodiment in which a label category error-correcting mechanism is introduced in training process of the semantic classification model in S103 to improve the classification capability of the semantic classification model. It is to be noted that for the part not detailed in the embodiment of the present disclosure, reference may be made to related expressions of other embodiments.

Further referring to FIG. 3, a classification model training method includes the steps described below.

S301, a sample query template and a label category of at least one category to be predicted in the sample query template are acquired, where the sample query template is constructed according to a sample query statement and the number of the at least one category to be predicted.

In S302, the sample query template is inputted to the semantic classification model to be pre-constructed to obtain the sample semantic category of the at least one category to be predicted.

In S303, a label anomaly type is determined according to the sample semantic category and the label category.

the label anomaly type is used for representing the difference between the sample semantic category and the label category from the type dimension.

Exemplarily, the label anomaly type may be determined according to the difference between the sample semantic category and the label category.

In an optional embodiment, in a case where the sample semantic category is a hyponym category of the label category, it is determined that the label anomaly type is a hypernym predicting hyponym type.

Specifically, if the label category and the sample semantic category have a hypernym-hyponym affiliation relationship, the label category is a hypernym category of the sample semantic category and the sample semantic category is a hyponym category of the label category, it is determined that the label anomaly type is the hypernym predicting hyponym type. For example, if the label category is “game”, the sample semantic category is “chess game”, and “chess game” is the hyponym category of “game”, at this time, the corresponding label anomaly type is the hypernym predicting hyponym type.

In another optional embodiment, in a case where the sample semantic category is a homologous deformation category of the label category, it is determined that the label anomaly type is a noise type.

The homologous deformation category of the label category can be understood as a category obtained by directly adding or deleting characters to the label category. Exemplarily, whether the sample semantic category is the homologous deformation category of the label category may be identified by determining the same character percentage or similarity between the label category and the sample semantic category. If the sample semantic category is the homologous deformation category of the label category, it is determined that the label anomaly type is the noise type. For example, the sample query statement is “a next statement of which prolonged illness makes a doctor of a patient”, and the label category corresponding to the category to be predicted under the intention system of the sample query statement is “other”, while the sample semantic category output by the semantic classification model is “other statement”. Since “other statement” is the homologous deformation category of “other”, the label anomaly type is set as the noise type.

In another optional embodiment, in a case where the sample semantic category is a combined category of a detachable category of the label category, it is determined that the label anomaly type is a confusion type.

The detachable category of the label category may be understood as a single-semantic split result of the label category of a composite semantic. The composite semantic may include at least two layers of single-semantics. For example, “Box office list” is the composite semantic of “box office” and “ranking list”, so the detachable categories corresponding to the label category “box office list” include “box office” and “ranking list”. If the sample semantic category is “box office list”, the label anomaly type is set as the confusion type.

It can be understood that the label anomaly type is refined to at least one of the hypernym predicting hyponym type, the noise type or the confusion type, thereby improving the richness and diversity of label anomaly types, limiting different label anomaly types, improving the determination mechanism of different label anomaly types, and laying a foundation for correcting label categories under different label anomaly types.

In S304, the label category is adjusted according to a label correction manner corresponding to the label anomaly type.

Exemplarily, different label correction manners may be set for different label anomaly types in advance, and accordingly, the label correction manner corresponding to the label anomaly types are used for correcting the abnormal label type.

In an optional embodiment, if the label anomaly type is the hypernym predicting hyponym type, the label category may be directly replaced with the sample semantic category.

Continuing the previous example, if the label category is “game”, and the sample semantic category is “chess game”, the label category is directly changed from “game” to “chess game”.

In another optional embodiment, in a case where the label anomaly type is the noise type, the label category is adjusted according to an alternative label of the homologous deformation category of the label category.

Exemplarily, one the alternative label may be selected from the alternative labels of the homologous deformation category of the label category as the label category. Optionally, the alternative category may be selected by determining the similarity between the sample query statement and the alternative label, or by using manual manner. The present disclosure does not limit any selection manner of the alternative label.

Continuing the previous example, if the sample query statement is “a next statement of which prolonged illness makes a doctor of a patient”, and the label category corresponding to the category to be predicted under the intention system of the sample query statement is “other”, while the sample semantic category output by the semantic classification model is “other statement”, “next statement” may be selected from the alternative labels “previous statement” and “next statement” of “other statement” as a new label category.

In another optional embodiment, if the label anomaly type is the confusion type, the label category is replaced with the sample semantic category or the detachable category of the label category.

Continuing the previous example, if the label category is “box office list”, and the sample semantic category is “box office ranking list”, under the single intention prediction scene, the single intention prediction can be changed into multi-category prediction under the single intention system, so that the label category is corrected to include “box office” and “ranking list”. Alternatively, under the single category prediction scene of double intention system, after there are the “box office” under the first intention system and “ranking list” under the second intention system, the label category of the new intention system “box office ranking list” is added.

It can be understood that the correction process of label category is refined under different label anomaly types, so that the diversity and richness of the correction process of label category are improved, and different label anomaly situations can be effectively dealt with, thus laying a foundation for further improving the accuracy of the semantic classification model.

In S305, the semantic classification model is trained according to the sample semantic category and the adjusted label category.

The semantic classification model is trained according to the adjusted label category instead of the anomaly labeled label category, thereby avoiding that the anomaly labeled label category are used for training network parameters of the semantic classification model, which causes poor performance and low accuracy of the semantic classification model, thus contributing to improving accuracy and robust of the semantic classification model.

The training process of the classification model is described in detail above, and the semantic classification process will be described in detail below.

Various semantic classification methods provided in the embodiments of the present disclosure is applicable to a scene in which semantic classification is performed, and in particular, semantic classification is performed according to a semantic classification model obtained by the foregoing classification model training method. The method may be performed by the semantic classification apparatus. The apparatus is implemented as software and/or hardware and disposed in an electronic device. The electronic device and the computing device performing the aforementioned classification model training method may be the same or different, which is not limited in the present disclosure.

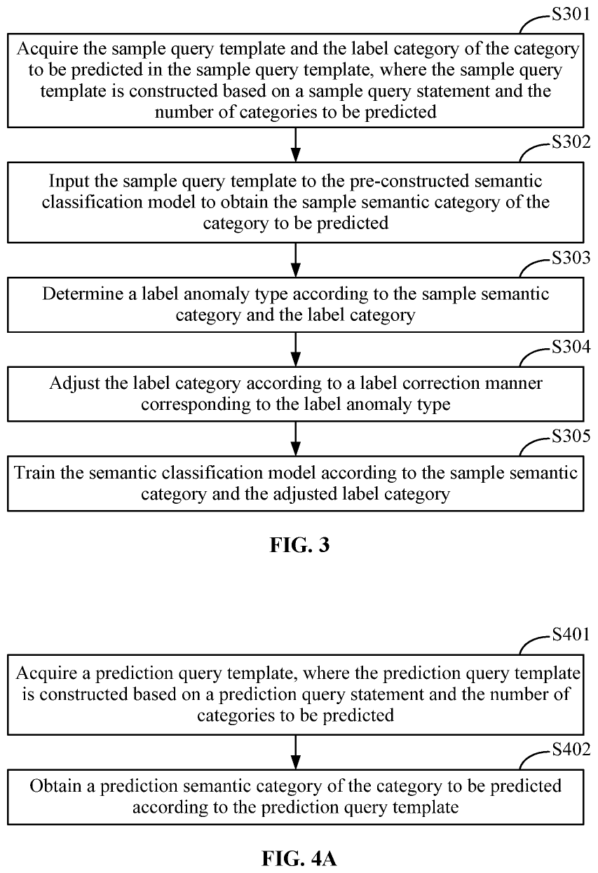

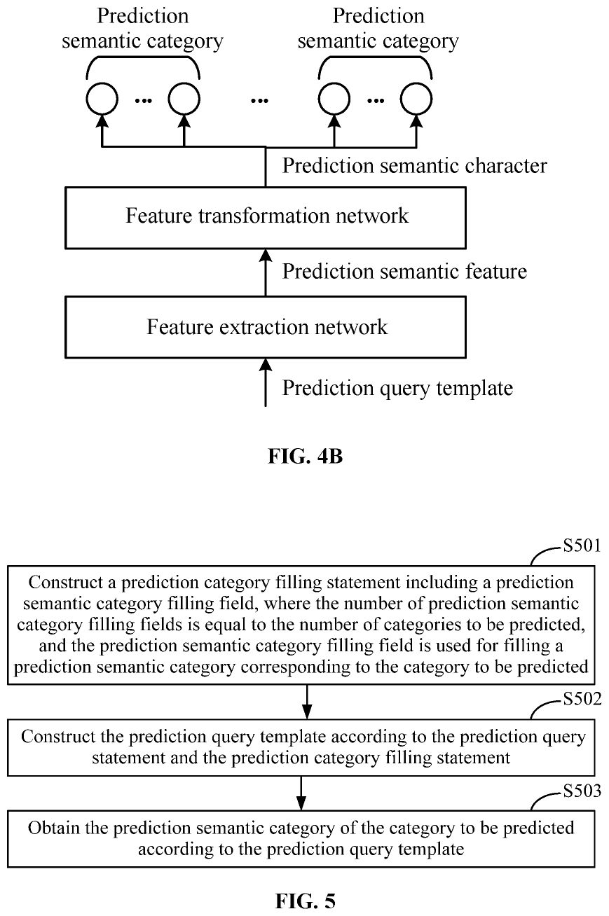

Referring to FIG. 4A, a semantic classification method includes the steps described below.

In S401, a prediction query template is acquired, where the prediction query template is constructed according to a prediction query statement and the number of at least one category to be predicted.

A query statement may be understood as a statement constructed by at least one semantic character, and the prediction query statement is a query statement to be performed the semantic category prediction in the semantic classification process. The category to be predicted may be understood as the category that can be predicted by the prediction query statement. The number of categories to be predicted may be set by a technician according to requirements or empirical values or determined by a large number of trials. The number of categories to be predicted is at least one. In order to avoid the omission of category prediction in a case of determining the categories to be predicted for different prediction query statement, the number of categories to be predicted is usually set to at least two, such as five.

It is be noted that the category to be predicted is at least one of the predictable categories, and generally the number of categories to be predicted will be significantly less than the number of predictable categories.

The prediction query template is a statement having a uniform format requirement constructed on the basis of the prediction query statement and the number of categories to be predicted. It is to be noted that the prediction query template may be stored locally in the computing device performing the semantic classification method, or in other storage devices or clouds associated with the computing device, and the corresponding data acquisition is performed when the semantic classification is required. The present disclosure does not limit the acquisition manner of the prediction query template.

Optionally, the prediction query statement may be acquired before performing the semantic classification, and the prediction query template may be constructed in real time according to the prediction query statement and the number of categories to be predicted.

It is be noted that the computing device acquiring the prediction query template may be the same as or different from the computing device constructing the prediction query template, which is not limited in the present disclosure.

In S402, a prediction semantic category of the at least one category to be predicted is obtained according to the prediction query template.

Exemplarily, the prediction query template may be used as input data of the trained semantic classification model, and the prediction semantic category of the category to be predicted may be determined according to the model output result. It is to be noted that the number of obtained prediction semantic categories is not greater than the number of categories to be predicted, and the present disclosure does not limit the specific number of prediction semantic categories. The semantic classification model may be trained by at least one classification model training method described above.

In an optional embodiment, the prediction query template may be inputted directly to the trained semantic classification model, and the output of the semantic classification model may be used as the prediction semantic category of the category to be predicted.

In another optional embodiment, at least one prediction semantic character of the category to be predicted may be determined according to the prediction query template, and at least one sample semantic character is combined in a prediction sequence to obtain the prediction semantic category of the category to be predicted.

The prediction semantic character of the category to be predicted may be understood as character information corresponding to the semantic feature of the extracted prediction query template under the dimension of the category to be predicted. The number of prediction semantic characters of each category to be predicted may be the same or different. The present disclosure only restricts the maximum number of prediction semantic characters of different categories to be predicted.

Exemplarily, the prediction query template may be inputted to the trained semantic classification model to obtain at least one prediction semantic character of the category to be predicted. Accordingly, for any dimension of the category to be predicted, since the number of prediction semantic characters is at least one, at least one prediction semantic character can be sequentially combined according to the prediction sequence of at least one prediction semantic character to obtain the prediction semantic category of the category to be predicted.

It can be understood that the prediction semantic characters are predicted in advance, and then the prediction sample characters are sequentially combined according to the prediction sequence to obtain the prediction semantic category of the category to be predicted, so as to determine the prediction semantic category, thereby improving the determination mechanism of the prediction semantic category. Meanwhile, since the particle size of the prediction semantic character is small, the semantic feature can be extracted by the character particle size, thereby improving the accuracy of the determined prediction semantic characters. Meanwhile, since there are many different prediction semantic characters, the richness and diversity of the determined prediction semantic categories are improved by combining the prediction semantic characters in different sequences.

Exemplarily, determining at least one prediction semantic character of the category to be predicted according to the prediction query template may include extracting a prediction semantic feature in the prediction query template; and performing feature transformation on the prediction semantic feature to obtain at least one prediction semantic character of the category to be predicted.

Specifically, in conjunction with the structure diagram of the semantic classification model shown in FIG. 4B, the semantic classification module may include a feature extraction network and a feature transformation network. For any category to be predicted, feature extraction may be performed on the prediction query template through the feature extraction network in the dimension of the category to be predicted to obtain the prediction semantic feature in the dimension of the category to be predicted, and the feature transformation is performed on the prediction semantic feature through the feature transformation network, thereby mapping the prediction semantic feature from a semantic feature space to a semantic character space, and matching the mapping result under the semantic character space with the standard semantic character library to obtain the prediction semantic character. Correspondingly, at least one prediction semantic character is combined in the prediction sequence to obtain the prediction semantic category of the category to be predicted.

The feature transformation may take the form of a linear feature transformation or a non-linear feature transformation, which is not limited by the present disclosure. The standard semantic character library may be set or adjusted by a technician according to requirements or empirical values or set by a large number of trials.

It is to be noted that in order to ensure the accuracy of the semantic classification result, when the prediction semantic characters are determined according to the semantic classification model, the maximum number of prediction semantic characters of the category to be predicted in the prediction query template should be consistent with the maximum number of sample semantic characters of the category to be predicted in the sample query template, the feature transformation manner used for the feature transformation should also be consistent, and the standard semantic character library used in the semantic classification process should also be consistent with the standard semantic character library used in the classification model training process.

It can be understood that the above technique solution only performs the determination of the prediction semantic character by means of feature transformation, without complicated data processing, thereby simplifying the data calculation amount in the process of determining the prediction semantic character, and contributing to improving the semantic classification efficiency.

Since the prediction semantic category can be obtained from sequentially combining the prediction semantic characters of at least one character prediction bit, in view of the diversity of prediction semantic characters, the prediction semantic categories obtained by sequential combination may not have actual semantics, thereby affecting the accuracy of the determination result of the prediction semantic category. For example, the prediction semantic characters of different character prediction bits are “entertainment”, “fast”, “person” and “object” respectively, and the prediction semantic category obtained by combination is “entertainment fast person object”, but “entertainment fast person object” has no actual semantics.

Optionally, it can be measured through the presence of the prediction semantic category in the standard semantic category library, if the prediction semantic category exists in the standard semantic category library, it indicates that the prediction semantic category has the actual semantic information, otherwise, the prediction semantic category does not have the actual semantic information. The standard semantic category library stores the standard semantic categories that can be used as the predictable categories, and various standard semantic categories have an actual semantic meaning. It is to be noted that the standard semantic category library may be set and adjusted by a technician according to requirements or empirical values, and which is also not limited in the present disclosure.

In order to improve the accuracy of the prediction semantic category, the number of prediction semantic characters having the same prediction sequence in at least one prediction semantic character are at least two in a case of determining the prediction semantic characters, that is, at the same character prediction bit, at least two prediction semantic characters are determined, and the possibility of setting different prediction semantic characters to the corresponding character prediction bit is distinguished by introducing the probability of the prediction semantic characters.

Correspondingly, combining, according to the prediction sequence, various prediction semantic characters to obtain the prediction semantic category of the category to be predicted may include: combining, according to the prediction sequence, various prediction semantic characters having different prediction sequences to obtain at least one candidate semantic category, determining a category prediction probability of at least one candidate semantic category according to character prediction probabilities of different prediction semantic characters in at least one candidate semantic category, and selecting the prediction semantic category from at least one candidate semantic category according to the category prediction probability and the matching result between at least one candidate semantic category and various standard semantic categories in the standard semantic category library.

Exemplarily, for any category to be predicted, character prediction probabilities in various character prediction bit under the category to be predicted are determined, prediction semantic characters of different character prediction bits are combined according to the prediction sequence to obtain the candidate semantic category, and the category prediction probability of the candidate semantic category are determined according to the character prediction probabilities of different prediction semantic characters in the candidate semantic category and according to a preset probability determination function. The preset probability determination function is an increasing function of the character prediction probability, a candidate semantic category having a high prediction probability (e.g., highest) and matching with various standard semantic categories in the standard semantic category library is selected from the candidate semantic categories as the prediction semantic category.

Specifically, at least one candidate semantic category of which the category prediction probability is large may be determined according to Beam search or Burkhard Keller Tree (Bk-tree), and the candidate semantic category having the high category prediction probability and matching with the standard semantic category in the standard semantic category library may be selected as the prediction semantic category.

Continuing the previous example, if the candidate semantic categories include “entertaining fast people object”, “entertaining people object”, “entertaining fast people” and “entertaining people”, and the category prediction probabilities decrease in turn, only “entertaining people object” is the standard semantic category in the standard semantic category library, “entertaining people object” is selected as the final prediction semantic category.

It is to be noted that when there is multi-system multi-category prediction, the standard semantic category library can be set for different systems by classification, so that the accuracy of the determination result of the prediction semantic category in each system can be improved, and the mixed use of the standard semantic category libraries in different systems can be avoided, resulting in an increase in calculation amount.

According to the above technical solution, at least two prediction semantic characters are determined in the same prediction sequence, and the character prediction probabilities of the prediction semantic characters are introduced to determine the category prediction probability, so that the prediction semantic categories are determined according to the category prediction probability and the standard semantic categories in the standard semantic category library, thereby avoiding inaccurate classification results in the semantic classification process, and contributing to improving the accuracy and reasonability of the classification prediction results.

In the embodiments of the present disclosure, the prediction semantic category of the categories to be predicted are obtained by acquiring the prediction query template constructed according to the prediction query template and the number of categories to be predicted, and according to the prediction query template. Since in the present disclosure, category prediction is performed according to a uniform prediction query template, and classification is performed from a semantic dimension rather than an inter-category difference dimension, a classification manner can be adapted to various classification scenes, and the generality of the semantic classification is improved.

Further, the prediction semantic categories of various categories to be predicted in the prediction query template are determined according to the trained semantic classification model. Since the model can dealt with the problem of sample imbalance in the prediction scene of the diversified categories, the small sample classification capability of the trained semantic classification model is improved, and the accuracy of the semantic classification results in the case of the small sample is improved.

On the basis of the above technical solutions, the present disclosure further provides an optional embodiment in which the construction mechanism of the prediction query template used in S401 is optimized. It is to be noted that for the part not detailed in the embodiment of the present disclosure, reference may be made to related expressions of other embodiments.

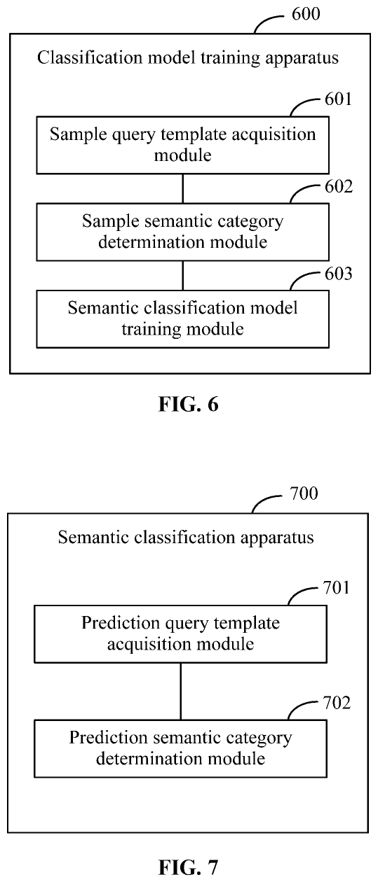

Further referring to FIG. 5, a semantic classification method includes the steps described below.

In S501, a prediction category filling statement including at least one prediction semantic category filling field is constructed, where the number of at least one prediction semantic category filling field is equal to the number of the at least one category to be predicted, and the at least one prediction semantic category filling field is used for filling a prediction semantic category corresponding to the at least one category to be predicted.

The prediction semantic category filling field may be a preset blank region or a region to which a preset identification is added. The preset identification may be set or adjusted by a technician according to requirements or empirical values, for example, the preset identification may be a null value or a “MASK” marking. It is to be noted that the preset identification herein may be the same as or different from the preset identification in the classification model training process. Preferably, the preset identifications used for both are the same.

It can be understood that to facilitate distinguishing different prediction semantic categories in the prediction category filling statement, field delimiters may be added between different prediction semantic category filling fields. The field delimiters may be implemented by using a preset character, and the present disclosure does not limit the specific expression of the preset character. For example, the preset character may be a comma, a pause, a space, other symbol, or the like.

It is to be noted that the categories to be predicted referred to in the present disclosure may be categories under the same system or categories under different systems. The systems to which the different categories to be predicted may be set and adjusted by a technician according to requirements or empirical values, and the kind of the systems is also not limited in the present disclosure.

For example, both the subject and the intention systems may be divided. A category having a species attribution attribute is divided into the subject system, for example, a figure, an entertainment figure, etc., which belong to the subject system. The category having a data acquisition intention is divided into the intention system, for example, height, weight, etc., which belong to the intention system.

When the number of categories to be predicted is at least one, and the systems to which different categories to be predicted belong are different, that is, the number of systems to which various categories to be predicted belong is at least one, for any system, the prediction system filling clause including the prediction semantic category filling field may be constructed, where the number of prediction semantic category filling fields is equal to the number of categories to be predicted under the any system; and the prediction category filling statement is determined according to different prediction system filling clauses.

Specifically, for any system, an equal number of prediction semantic category filling fields are set according to the number of categories to be predicted under the any system, and the prediction system filling clause including the set prediction semantic category filling fields is constructed. When the number of categories to be predicted corresponds to at least two systems, the prediction category filling statement is determined according to various prediction system filling clauses corresponding to different systems.

Exemplarily, prediction system filling clauses corresponding to different systems may be combined to obtain the prediction category filling statement. Further, in order to facilitate dividing the categories to be predicted in different systems, clause delimiters may be set between the different prediction system filling clauses in a case of generating the prediction category filling statements. The clause delimiters may be implemented by using a preset character, and the present disclosure does not limit the specific expression of the preset character. For example, the preset character may be a comma, a pause, a space, other symbol, or the like. It is to be noted that the clause delimiters may be the same as or different from the preceding field delimiters, and it is only necessary to ensure that different prediction system filling clauses can be distinguished.

It can be understood that, by introducing a system to which the category to be predicted belongs, the prediction system filling clause is constructed for each system, and then the prediction category filling statement is determined according to the prediction system filling clause so that the generated prediction category filling statement can be systemically divided into the category to be predicted. Meanwhile, since the prediction category filling statement is used as the basis for generating the prediction query template, it is convenient to add or adjust the system, so that the prediction category filling statement can adapt to classification scenes of multiple systems, and the generality of the semantic classification is improved.

Further, when the multi-system multi-category prediction query template is introduced, if the prediction query template is processed according to the trained semantic classification model, cross-enhancement of semantic features in different dimensions is generally performed inside the model, so that richness and accuracy of semantic features extracted by the semantic classification model are improved, and accuracy of semantic classification in multi-system multi-classification is further improved.

It is to be noted that in order to facilitate dividing the categories to be predicted in different systems, same field delimiters may be set between the prediction system filling clauses in the same systems, and different field delimiters may be set in different prediction system filling clauses.

It is to be noted that the field delimiters in the embodiments of the present disclosure may be the same as or different from the field delimiters used in the classification model training process, and the clause delimiters in the embodiments of the present disclosure may be the same as or different from the clause delimiters used in the classification model training process. Preferably, the field delimiters in the embodiments of the present disclosure is the same as the field delimiters used in the classification model training process, and the clause delimiters in the embodiments of the present disclosure is also the same as the clause delimiters used in the classification model training process.

In S502, the prediction query template including according to the prediction query statement and the prediction category filling statement.

The prediction query template including the prediction query statement and the prediction category filling statement is generated.

Exemplarily, the prediction query statement and the prediction category filling statement are combined to obtain the prediction query template. Further, in order to ensure the readability of the obtained prediction query template after the prediction semantic category is filled in the prediction semantic category filling field of the prediction query template when the prediction semantic category is predicted subsequently, a connection statement may be added between the prediction query statement and the prediction category filling statement when the prediction query template is constructed. The connection statement may be set artificially, for example, the connection statement may be a conjunction. Of course, in order to enhance the readability of the prediction query template of which the prediction semantic category filling field is filled by the prediction semantic category, the connection statement may be added between different prediction system filling clauses. The present disclosure does not limit the number and content of connection statements at different positions in the prediction query template.

It is to be noted that the connection statement used herein may be the same as or different from the connection statement used in the classification model training process. Preferably, the connection statements used for both are correspondingly the same.

For example, if the prediction query statement is “Zhang San's height and weight”, the system to which the category to be predicted belongs includes the subject system and the intention system, and the number of categories to be predicted corresponding to each system is three, the following template can be constructed: “Zhang San's height and weight are “[MASK], [MASK], [MASK]; [MASK], [MASK], [MASK]”. “[MASK]” is the prediction semantic category filling field, “[MASK], [MASK], [MASK]; [MASK], [MASK], [MASK]” is the prediction category filling statement; “is” is a conjunction, and “[MASK], [MASK], [MASK]” is the prediction system filling clause corresponding to the subject system, where “,” is the field delimiter corresponding to the subject system; and “[MASK], [MASK], [MASK]” is the prediction system filling clause corresponding to the intention system, where “,” is the field delimiter corresponding to the intention system, and “;” is the clause delimiter between the prediction system filling clauses in different systems. Of course, the constructed prediction query template is only described above exemplarily, and is not to be construed as limiting the construction manner of the prediction query template.

In S503, a prediction semantic category of the category to be predicted is obtained according to the prediction query template.

In the embodiments of the present disclosure, the prediction category filling statement is constructed by introducing the prediction semantic category filling field, and the prediction query template is constructed according to the prediction query statement and the prediction category filling statement, thereby improving the construction mechanism of the prediction query template and providing data support for subsequently determining the prediction semantic category. Meanwhile, the prediction query templates are generated for different prediction query statements in the uniform manner described above, which is convenient for batch processing of prediction query statements and is helpful for improving semantic classification efficiency.

As an implementation of the preceding classification model training methods, the present disclosure further provides an optional embodiment of an execution apparatus for implementing the various classification model training methods. The apparatus is applicable to a scene in which the semantic classification model training is performed, implemented as software and/or hardware and specifically disposed in an electronic device.

Further referring to the classification model training apparatus 600 shown in FIG. 6, the classification model training apparatus 600 includes a sample query template acquisition module 601, a sample semantic category determination module 602, and a semantic category model training module 603.

The sample query template acquisition module 601 is configured to acquire a sample query template and a label category of at least one category to be predicted in the sample query template, where the sample query template is constructed according to a sample query statement and the number of the at least one category to be predicted.

The sample semantic category determination module 602 is configured to input the sample query template to the semantic classification model to be pre-constructed to obtain a sample semantic category of the at least one category to be predicted.

The semantic classification model training module 603 is configured to train the semantic classification model according to the sample semantic category and the label category of the at least one category to be predicted.

Since the present disclosure trains the semantic classification model according to a uniform sample query template, and performs the sample classification from a semantic dimension rather than an inter-category difference dimension, the trained semantic classification model can adapt to various classification scenes, and different classification models do not need to be trained for different classification scenes, thereby improving the generality of the trained semantic classification model. Meanwhile, the uniform integration of various sample query statements in the form of templates can effectively deal with the problem of sample imbalance in various category prediction scenes, thereby contributing to improving the small sample classification capability of the trained semantic classification model.

In an optional embodiment, the apparatus 600 further includes a sample query template construction module, including a sample category filling statement construction unit and a sample query template construction unit.

The sample category filling statement construction unit is configured to construct a sample category filling statement including at least one sample semantic category filling field, where the number of the at least one sample semantic category filling field is equal to the number of the at least one category to be predicted, and the at least one sample semantic category filling field is used for filling a sample semantic category corresponding to the at least one category to be predicted.

The sample query template construction unit is configured to construct the sample query template according to the sample query statement and the sample category filling statement.

In an optional embodiment, the number of systems to which the category to be predicted belongs is at least one.

The sample category filling statement construction unit includes a sample system filling clause construction subunit and a sample category filling statement determination subunit.

The sample system filling clause construction subunit is configured to construct, for each system, a sample system filling clause including the at least one sample semantic category filling field in each system, where the number of the at least one sample semantic category filling field is equal to the number of the at least one category to be predicted under the either system.

The sample category filling statement determination subunit is configured to determine the sample category filling statement according to sample system filling clauses in all system.

In an optional embodiment, for the sample category filing statement, a clause delimiter is provided between sample system filling clauses in different system; and/or for each system, a field delimiter is provided between sample semantic category filling fields of the sample system filling clause.

In an optional embodiment, in a case where, for each system, the field delimiter is provided between the sample semantic category filing filed of the sample system filling clause, field delimiters in a same sample system filling clause are the same, and field delimiters in different sample system filling clauses are different.

In an optional embodiment, the semantic classification model training module 603 includes a label anomaly category determination unit, a label category adjustment unit and a semantic classification model training unit.

The label anomaly category determination unit is configured to determine a label anomaly type according to the sample semantic category and the label category.

The label category adjustment unit is configured to adjust the label category according to a label correction manner corresponding to the label anomaly type.

The semantic classification model training unit is configured to train the semantic classification model according to the sample semantic category and the adjusted label category.

In an optional embodiment, the label anomaly type determination unit includes a hypernym-hyponym type determination subunit, a noise type determination subunit and a confusion type determination subunit.

The hypernym-hyponym type determination subunit is configured to, in a case where the sample semantic category is a hyponym category of the label category, determine that the label anomaly type is a hypernym predicting hyponym type.

The noise type determination subunit is configured to, in a case where the sample semantic category is a homologous deformation category of the label category, determine that the label anomaly type is a noise type.

The confusion type determination subunit is configured to, in a case where the sample semantic category is a combined category of a detachable category of the label category, determine that the label anomaly type is a confusion type.

In an optional embodiment, the label category adjustment unit includes a hypernym-hyponym type adjustment subunit, a noise type adjustment subunit and a confusion type determination subunit.

The hypernym-hyponym type adjustment subunit is configured to, in a case where the label abnormality type is the hypernym predicting hyponym type, replace the label category as the sample semantic category.

The noise type adjustment subunit is configured to, in a case where the label anomaly type is the noise type, adjust the label category according to an alternative label of the homologous deformation category of the label category.

The confusion type determination subunit is configured to, in a case where the label anomaly category is the confusion type, replace the label category as the sample semantic category or the detachable category of the label category.

In an optional embodiment, the sample semantic category determination module 602 includes a sample semantic character determination unit and a sample semantic category determination unit.

The sample semantic character determination unit is configured to input the sample query template to the pre-constructed semantic classification model to obtain at least one sample semantic character of the category to be predicted.

The sample semantic category determination unit is configured to combine the at least one sample semantic character in a prediction sequence to obtain the sample semantic category of the category to be predicted.

In an optional embodiment, the sample semantic character determination unit is specifically configured to input the sample query template to the pre-constructed semantic classification model to extract a sample semantic feature in the sample query template, and perform feature transformation on the sample semantic feature to obtain at least one sample semantic character of the category to be predicted.

The classification model training apparatus described above can perform the classification model training method provided in any embodiment of the present disclosure and has functional modules and beneficial effects corresponding to various classification model training methods executed.

As an implementation of the preceding semantic classification methods, the present disclosure further provides an optional embodiment of an execution apparatus for implementing the various semantic classification methods described above. The device is suitable for performing the semantic classification, and in particular, a scene in which the semantic classification is performed according to the semantic classification model obtained by the aforementioned classification model training method. This apparatus may be implemented by a software or hardware, and this apparatus is specifically disposed in an electronic device.

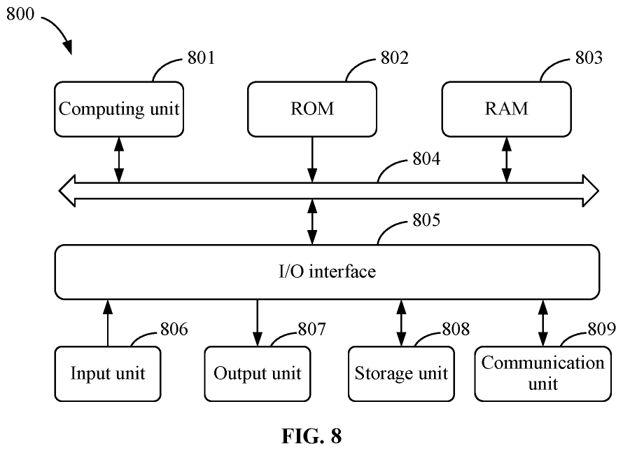

Further referring to the semantic classification apparatus 700 shown in FIG. 7, the semantic classification apparatus 700 includes a sample query template acquisition module 701, and a prediction semantic category determination module 702.

The prediction query template acquisition module 701 is configured to acquire a prediction query template, where the prediction query template is constructed according to a prediction query statement and the number of categories to be predicted.

The prediction semantic category determination module 702 is configured to obtain a prediction semantic category of the category to be predicted according to the prediction query template.

In the embodiments of the present disclosure, the prediction semantic category of the categories to be predicted are obtained by acquiring the prediction query template constructed according to the prediction query template and the number of categories to be predicted, and according to the prediction query template. Since in the present disclosure, category prediction is performed according to a uniform prediction query template, and classification is performed from a semantic dimension rather than an inter-category difference dimension, a classification manner can be adapted to various classification scenes, and the generality of the semantic classification is improved.

In an optional embodiment, the apparatus 700 further includes a prediction query template construction module, including a prediction category filling statement construction unit and a prediction query template construction unit.

The prediction category filling statement construction unit is configured to construct a prediction category filling statement including a prediction semantic category filling field, where the number of prediction semantic category filling fields is equal to the number of categories to be predicted, and the prediction semantic category filling field is used for filling a prediction semantic category corresponding to the category to be predicted.

The prediction query template construction unit is configured to construct the prediction query template according to the prediction query statement and the prediction category filling statement.

In an optional embodiment, the number of systems to which the category to be predicted belongs is at least one.

The prediction category filling statement construction unit includes a prediction system filling clause construction subunit and a prediction category filling statement construction subunit.

The prediction system filling clause construction subunit is configured to construct, for either system, a prediction system filling clause comprising the prediction semantic category filling field, where the number of prediction semantic category filling fields is equal to a number of categories to be predicted under the either system.

The prediction category filling statement construction subunit is configured to determine the prediction category filling statement according to different prediction system filling clauses.

In an optional embodiment, for the prediction category filing statement, a clause delimiter is provided between different prediction system filling clauses in different system; and/or for each system, a field delimiter is provided between prediction semantic category filling fields of the prediction system filling clause.

In an optional embodiment, in a case where the field delimiter is provided in the prediction system filling clause, field delimiters in a same prediction system filling clause are the same, and field delimiters in different prediction system filling clauses are different.

In an optional embodiment, the prediction semantic category determination module 702 includes a prediction semantic character determination unit and a prediction semantic category determination unit.

The prediction semantic character determination module is configured to determine at least one prediction semantic character of the category to be predicted according to the prediction query template.

The prediction semantic category determination unit is configured to combine the at least one prediction semantic character in a prediction sequence to obtain the prediction semantic category of the category to be predicted.

In an optional embodiment, the at least one prediction semantic character includes at least two prediction semantic characters having a same prediction sequence.

The prediction semantic category determination unit includes a candidate semantic category determination subunit, a category prediction probability determination subunit and a prediction semantic category selection subunit.

The candidate semantic category determination subunit is configured to combine prediction semantic characters having different prediction sequences in the prediction sequence to obtain at least one candidate semantic category.

The category prediction probability determination subunit is configured to determine a category prediction probability of the at least one candidate semantic category according to character prediction probabilities of different prediction semantic characters in the at least one candidate semantic category.

The prediction semantic category selection subunit is configured to select the prediction semantic category from the at least one candidate semantic category according to the category prediction probability and a matching result between the at least one candidate semantic category and each standard semantic category in a standard semantic category library.

In an optional embodiment, the prediction semantic character determination module includes a prediction semantic feature extraction subunit and a prediction semantic character determination subunit.

The prediction semantic feature extraction subunit is configured to extract a prediction semantic feature in the prediction query template.

The prediction semantic character determination subunit is configured to perform feature transformation on the prediction semantic feature to obtain the at least one prediction semantic character of the category to be predicted.

The preceding semantic classification apparatus may perform the semantic classification method provided by any embodiment of the present disclosure and has corresponding functional modules and beneficial effects for performing the various semantic classification methods.

Operations, including collection, storage, use, processing, transmission, provision, and disclosure, on the sample query template, the label category, and the prediction query template involved in the technical solutions of the present disclosure conform to relevant laws and regulations and do not violate the public policy doctrine.

According to embodiments of the present disclosure, the present disclosure further provides an electronic device, a readable storage medium, and a computer program product.

FIG. 8 is a block diagram illustrative of an exemplary electronic device 800 that may be configured to implement embodiments of the present disclosure. Electronic devices are intended to represent various forms of digital computers, for example, laptop computers, desktop computers, worktables, personal digital assistants, servers, blade servers, mainframe computers and other applicable computers. Electronic devices may further represent various forms of mobile apparatuses, for example, personal digital assistants, cellphones, smartphones, wearable devices and other similar computing apparatuses. Herein the shown components, the connections and relationships between these components, and the functions of these components are illustrative only and are not intended to limit the implementation of the present disclosure as described and/or claimed herein.

As shown in FIG. 8, the device 800 includes a computing unit 801. The computing unit 801 may perform various types of appropriate operations and processing based on a computer program stored in a read-only memory (ROM) 802 or a computer program loaded from a storage unit 808 to a random-access memory (RAM) 803. Various programs and data required for operations of the device 800 may also be stored in the RAM 803. The computing unit 801, the ROM 802, and the RAM 803 are connected to each other through a bus 804. An input/output (I/O) interface 805 is also connected to the bus 804.

Multiple components in the device 800 are connected to the I/O interface 805. The components include an input unit 806 such as a keyboard and a mouse, an output unit 807 such as various types of displays and speakers, the storage unit 808 such as a magnetic disk and an optical disc, and a communication unit 809 such as a network card, a modem and a wireless communication transceiver. The communication unit 809 allows the device 800 to exchange information/data with other devices over a computer network such as the Internet and/or various telecommunications networks.

The computing unit 801 may be various general-purpose and/or special-purpose processing components having processing and computing capabilities. Examples of the computing unit 801 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller and microcontroller. The computing unit 801 performs various methods and processing described above, such as the classification model training method and/or the semantic classification method. For example, in some embodiments, the classification model training method and/or the semantic classification method may be implemented as a computer software program tangibly contained in a machine-readable medium such as the storage unit 808. In some embodiments, part or all of computer programs may be loaded and/or installed on the device 800 via the ROM 802 and/or the communication unit 809. When the computer programs are loaded into the RAM 803 and performed by the computing unit 801, one or more steps of the preceding classification model training method and/or the semantic classification method may be performed. Alternatively, in other embodiments, the computing unit 801 may be configured, in any other suitable manner (for example, by means of firmware), to perform the classification model training method and/or the semantic classification method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software and/or combinations thereof. The various embodiments may include implementations in one or more computer programs. The one or more computer programs are executable and/or interpretable on a programmable system including at least one programmable processor. The at least one programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Program codes for implementation of the methods of the present disclosure may be written in one programming language or any combination of multiple programming languages. These program codes may be provided for the processor or controller of a general-purpose computer, a special-purpose computer, or another programmable data processing apparatus to cause functions/operations specified in flowcharts and/or block diagrams to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, the machine-readable medium may be a tangible medium that may include or store a program that is used by or in conjunction with a system, apparatus or device that executes instructions. The machine-readable medium may be a machine-readable signal medium or a machine-readable storage medium. The machine-readable medium may include, but is not limited to, an electronic, magnetic, optical, electromagnetic, infrared, or semiconductor system, apparatus or device or any appropriate combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device or any appropriate combination thereof.

In order that interaction with a user is provided, the systems and techniques described herein may be implemented on a computer. The computer has a display device (for example, a cathode-ray tube (CRT) or a liquid-crystal display (LCD) monitor) for displaying information to the user and a keyboard and a pointing device (for example, a mouse or a trackball) through which the user can provide input to the computer. Other types of devices may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

The computing system may include clients and servers. The clients and the servers are usually far away from each other and generally interact through the communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS). The server may also be a server of a distributed system, or a server combined with a blockchain.

Artificial intelligence is a discipline studying the simulation of certain human thinking processes and intelligent behaviors (such as learning, reasoning, thinking, and planning) by a computer and involves techniques at both hardware and software levels. Hardware techniques of artificial intelligence generally include techniques such as sensors, special-purpose artificial intelligence chips, cloud computing, distributed storage, and big data processing. Software techniques of artificial intelligence mainly include several major directions such as computer vision technology, speech recognition technology, natural language processing technology, machine learning/deep learning technology, big data processing technology, and knowledge graph technology.

It is to be understood that various forms of the preceding flows may be used, with steps reordered, added, or removed. For example, the steps described in the present disclosure may be executed in parallel, in sequence, or in a different order as long as the desired result of the technical solutions provided in the present disclosure is achieved. The execution sequence of these steps is not limited herein.

The scope of the present disclosure is not limited to the preceding embodiments. It is to be understood by those skilled in the art that various modifications, combinations, sub-combinations, and substitutions may be made depending on design requirements and other factors. Any modifications, equivalent substitutions, improvements, and the like made within the spirit and principle of the present disclosure are within the scope of the present disclosure.

What is claimed is:

1. A semantic classification model training method, comprising:
acquiring a sample query template and a label category of at least one category to be predicted in the sample query template, wherein the sample query template is constructed according to a sample query statement and a number of the at least one category to be predicted;
inputting the sample query template to the semantic classification model to be pre-constructed to obtain a sample semantic category of the at least one category to be predicted; and
training the semantic classification model according to the sample semantic category and the label category of the at least one category to be predicted.

2. The method of claim 1, wherein the sample query template is constructed in the following manner:
constructing a sample category filling statement comprising at least one sample semantic category filling field, wherein a number of the at least one sample semantic category filling field is equal to the number of the at least one category to be predicted, and the at least one sample semantic category filling field is used for filling a sample semantic category corresponding to the at least one category to be predicted; and
constructing the sample query template according to the sample query statement and the sample category filling statement.

3. The method of claim 2, wherein
at least one system to which the at least one category to be predicted belongs is provided; and
constructing the sample category filling statement comprising the at least one sample semantic category filling field, comprises:
for each system of the at least one system, constructing a sample system filling clause comprising at least one of sample semantic category filling field in each system, wherein a number of the at least one sample semantic category filling field in each system is equal to a number of at least one category to be predicted in each system; and
determining the sample category filling statement according to sample system filling clauses in all of the at least one system.

4. The method of claim 3, wherein
for the sample category filing statement, a clause delimiter is provided between sample system filling clauses in different systems of the at least one system; and/or
for each system, a field delimiter is provided between the at least one sample semantic category filling field of the sample system filling clause.

5. The method of claim 4, wherein in a case where, for each system, the field delimiter is provided between the at least one sample semantic category filing filed of the sample system filling clause, field delimiters in a same system are the same, and field delimiters in different systems are different.

6. The method of claim 1, wherein training the semantic classification model according to the sample semantic category and the label category of the at least one category to be predicted, comprises:
determining a label anomaly type according to the sample semantic category and the label category;
adjusting the label category according to a label correction manner corresponding to the label anomaly type; and
training the semantic classification model according to the sample semantic category and the adjusted label category.

7. The method of claim 6, wherein determining the label anomaly type according to the sample semantic category and the label category, comprises:
in a case where the sample semantic category is a hyponym category of the label category, determining that the label anomaly type is a hypernym predicting hyponym type;
in a case where the sample semantic category is a homologous deformation category of the label category, determining that the label anomaly type is a noise type; or
in a case where the sample semantic category is a combined category of a detachable category of the label category, determining that the label anomaly type is a confusion type.

8. The method of claim 7, wherein adjusting the label category according to the label correction manner corresponding to the label anomaly type, comprises:
in a case where the label anomaly type is the hypernym predicting hyponym type, replacing the label category as the sample semantic category;
in a case where the label anomaly type is the noise type, adjusting the label category according to an alternative label of the homologous deformation category of the label category; or
in a case where the label anomaly category is the confusion type, replacing the label category as the sample semantic category or the detachable category of the label category.

9. The method of claim 1, wherein inputting the sample query template to the pre-constructed semantic classification model to obtain the sample semantic category of the category to be predicted, comprises:
inputting the sample query template to the pre-constructed semantic classification model to obtain at least one sample semantic character of the category to be predicted; and
combining the at least one sample semantic character in a prediction sequence to obtain the sample semantic category of the category to be predicted.

10. The method of claim 9, wherein inputting the sample query template to the pre-constructed semantic classification model to obtain the at least one sample semantic character of the category to be predicted, comprises:
inputting the sample query template to the pre-constructed semantic classification model to extract a sample semantic feature in the sample query template; and
performing feature transformation on the sample semantic feature to obtain the at least one sample semantic character of the category to be predicted.

11. A semantic classification method, comprising:
acquiring a prediction query template, wherein the prediction query template is constructed according to a prediction query statement and a number of at least one category to be predicted; and
obtaining a prediction semantic category of the at least one category to be predicted according to the prediction query template.

12. The method of claim 11, wherein the prediction query template is constructed in the following manner:
constructing a prediction category filling statement comprising at least one prediction semantic category filling field, wherein a number of the at least one prediction semantic category filling field is equal to the number of the at least one category to be predicted, and the at least one prediction semantic category filling field is used for filling a prediction semantic category corresponding to the at least one category to be predicted; and
constructing the prediction query template according to the prediction query statement and the prediction category filling statement.

13. The method of claim 12, wherein
at least one system to which the at least one category to be predicted belongs is provided;
constructing the prediction category filling statement comprising the at least one prediction semantic category filling field, comprises:
for each system of the at least one system, constructing a prediction system filling clause comprising at least one prediction semantic category filling field in each system; wherein a number of the at least one prediction semantic category filling field in each system is equal to a number of at least one category to be predicted in each system; and
determining the prediction category filling statement according to prediction system filling clauses in all of the at least one system.

14. The method of claim 13, wherein
for the prediction category filling statement, a clause delimiter is provided between prediction system filling clauses in different systems of the at least one system; and/or
for each system, a field delimiter is provided between the at least one prediction semantic category filling fields of the prediction system filling clause.

15. The method of claim 14, wherein in a case where, for each system, the field delimiter is provided between the at least one prediction semantic category filling fields of the prediction system filling clause, field delimiters in a same system are the same, and field delimiters in different systems are different.

16. The method of claim 11, wherein obtaining the prediction semantic category of the at least one category to be predicted according to the prediction query template, comprises:
determining at least one prediction semantic character of the at least one category to be predicted according to the prediction query template; and
combining the at least one prediction semantic character in a prediction sequence to obtain the prediction semantic category of the at least one category to be predicted.

17. The method according to claim 16, wherein
the at least one prediction semantic character comprises at least two prediction semantic characters having a same prediction sequence; and
combining the at least one prediction semantic character in the prediction sequence to obtain the prediction semantic category of the at least one category to be predicted, comprises:
combining prediction semantic characters having different prediction sequences in the prediction sequence to obtain at least one candidate semantic category;
determining a category prediction probability of the at least one candidate semantic category according to character prediction probabilities of different prediction semantic characters in the at least one candidate semantic category; and
selecting the prediction semantic category from the at least one candidate semantic category according to the category prediction probability and a matching result between the at least one candidate semantic category and each standard semantic category in a standard semantic category library.

18. The method of claim 16, wherein determining the at least one prediction semantic character of the at least one category to be predicted according to the prediction query template, comprises:
extracting a prediction semantic feature in the prediction query template; and
performing feature transformation on the prediction semantic feature to obtain the at least one prediction semantic character of the at least one category to be predicted.

19. An electronic device, comprising:
at least one processor; and
a memory communicatively connected to the at least one processor;
the memory stores instructions executable by the at least one processor, and the instructions are executed by the at least one processor to cause the at least one processor to perform the classification model training method of claim 1.

20. Anon-transitory computer-readable storage medium storing computer instructions for causing a computer to perform the classification model training method of claim 1.
